(19) United States
(12) Patent Application Publication
(10) Pub. No.: US 2022/0221676 A1
(43) Pub. Date: Jul. 14, 2022

(54) HYBRID ELECTRO-OPTICAL CABLE HAVING A HYDROGEN DELAY BARRIER

(71) Applicant: Halliburton Energy Services, Inc., Houston, TX (US)

(72) Inventors: John Laureto Maida, Houston, TX (US); Michel Joseph LeBlanc, Houston, TX (US); Glenn Wilson, Houston, TX (US)

(21) Appl. No.: 17/564,359

(22) Filed: Dec. 29, 2021

Related U.S. Application Data
(60) Provisional application No. 63/137,244, filed on Jan. 14, 2021.

(51) Int. Cl. G02B 6/44; E21B 47/12

(52) U.S. Cl. CPC G02B 6/4492; G02B 6/4427; E21B 47/12

(57) ABSTRACT

Certain aspects and features of the present disclosure relate to a communication cable for use in a wellbore. The cable can be a hybrid electro-optical cable that includes a tube including one or more optical fibers. The hybrid electro-optical cable can also include a hydrogen-delay barrier encapsulating the tube and at least one insulated conductor. An outer tube can encapsulate both the hydrogen-delay barrier and the at least one insulated conductor.

### CROSS-REFERENCE TO RELATED APPLICATION

This claims priority to U.S. Ser. No. 63/137,244, titled “A Hybrid Electro-Optical Cable Having A Hydrogen-Delay Barrier” and filed Jan. 14, 2021, the entirety of which is incorporated herein by reference.

### TECHNICAL FIELD

The present disclosure relates generally to a wellbore operation tools, and more particularly (although not necessarily exclusively), to a hybrid electro-optical cable with a hydrogen-delay barrier.

### BACKGROUND

Wellbore operations can be used to explore and recover natural resources such as water, oil, and gas. Examples of wellbore operations can include cleaning operations, drilling operations, plugging operations, completion operations, and production operations. Sensing and measurement tools can be deployed downhole to measure conditions in the wellbore. As an example, optical cables may be used with sensing and measurement tools for distributed temperature sensing, distributed strain sensing, and distributed acoustic sensing during wellbore operations.

### BRIEF DESCRIPTION OF THE DRAWINGS

FIG. 1 is a cross-sectional view of an example of a well system that includes a hybrid electro-optical cable according to one example of the present disclosure.

FIG. 2 is a cross-sectional schematic of an example of a hybrid electro-optical cable with insulated conductors and an optical fiber within a tube having a hydrogen-delay barrier according to some aspects of the present disclosure.

FIG. 3 is a cross-sectional schematic of an example of a hybrid electro-optical cable with a concentric insulated conductor and tube with a hydrogen-delay barrier according to some aspects of the present disclosure.

FIG. 4 is a cross-sectional schematic of another example of a hybrid electro-optical cable with insulated conductors and an optical fiber within a tube having a hydrogen-delay barrier according to some aspects of the present disclosure.

FIG. 5 is a cross-sectional schematic of an example of a hybrid electro-optical cable with multiple concentrically arranged insulated conductors and a tube with a hydrogen-delay barrier according to some aspects of the present disclosure.

FIG. 6 is a cross-sectional schematic of an example of a wireline-configured hybrid electro-optical cable with a hydrogen-delay barrier according to some aspects of the present disclosure.

FIG. 7 is a flowchart of a process for using a hybrid electro-optical cable to transmit data during a wellbore operation according to some aspects of the present disclosure.

### DETAILED DESCRIPTION

Certain aspects and examples of the present disclosure relate to a hybrid electro-optical cable with a hydrogen-delay barrier to reduce hydrogen darkening. A hydrogen-delay barrier may delay permeation of hydrogen into a space that the hydrogen-delay barrier encapsulates. Hydrogen darkening may be a degradation of glass that can decrease an ability of an optical fiber to transmit optical signals. Hybrid electro-optical cables can be used for sensing during wellbore operations. A hybrid electro-optical cable can include one or more optical fibers in a tube and one or more insulated electrical conductors. The insulated electrical conductors can be used for providing power or telemetry to electric gauges, and the tube can support the optical fibers. The optical fibers can include glass, which may be susceptible to hydrogen darkening.

Enhanced backscatter fibers can provide increased backscattering above Rayleigh-limited backscattering levels, which, when included in a tube, can improve the signal-to-noise ratio of distributed acoustic measurements for reservoir diagnostics and vertical seismic profiling. Enhanced backscatter fibers may not have full coverage carbon coatings or other impermeable coating materials, and may thus be susceptible to hydrogen-permeation-induced attenuation or darkening. Without a hydrogen mitigation strategy, the enhanced backscatter fibers may darken and may provide inadequate return signal strength resulting in inaccurate sensing measurement over the life of a well. Other hybrid electro-optical cable designs typically include a fiber-in-metal tube that encapsulates carbon-coated fibers in a hydrogen scavenging gel. But, these designs may not be compatible with enhanced backscatter fibers, as the enhanced backscatter fibers used in examples of the present disclosure may involve an incomplete carbon coating or no carbon coating.

Some aspects of the present disclosure may provide a hybrid electro-optical cable with a hydrogen-delay barrier for reducing hydrogen permeation into a core of the hybrid electro-optical cable. The hydrogen delay barrier may be impermeable to hydrogen over extended period of time, such as decades or centuries, at elevated wellbore temperatures and pressures. The hydrogen-delay barrier can allow an enhanced backscatter fiber to be deployed in a hybrid electro-optical cable for reduced hydrogen darkening over long time periods. The optical fibers of the hybrid electro-optical cable may be single-mode fibers or multimode fibers for distributed temperature sensing, distributed strain sensing, or distributed acoustic sensing. The delay time for hydrogen may be due to diffusion transit time through the hydrogen-delay barrier and hydrogen traps related to hydrogen solubility within the barrier material. Once the hydrogen-delay barrier is fully saturated with hydrogen or internal hydride formation sites are exhausted, excess hydrogen may eventually break through across the hydrogen-delay barrier with a flux rate dependent on surface area, differential partial pressure of hydrogen, and diffusivity at temperature. As a result of the hydrogen-delay barrier, measurements of the hybrid electro-optical cable may have increased operational lifetimes, measurement reliability, and accuracy over long time periods.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

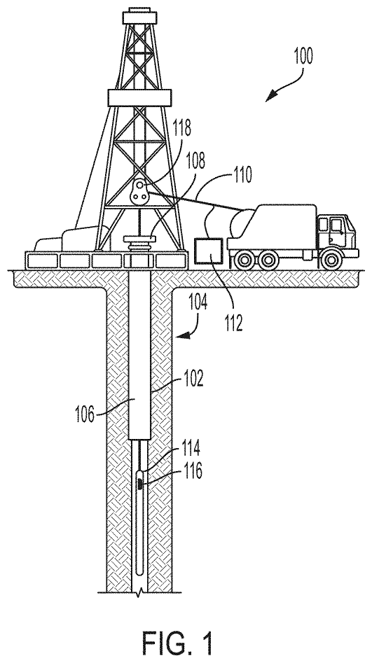

FIG. 1 is a cross-sectional view of an example of a well system 100 that includes a hybrid electro-optical cable 110 according to one example of the present disclosure. In the example shown in FIG. 1, the well system 100 includes a wellbore 102 extending through a hydrocarbon bearing subterranean formation 104. A casing string 106 extends from the well surface 108 into the subterranean formation 104. The casing string 106 can provide a conduit via which formation fluids, such as production fluids produced from the subterranean formation 104, can travel from the wellbore 102 to the well surface 108.

The well system 100 can also include a well tool 114 (e.g., a formation testing tool, a logging while drilling tool, or a reservoir monitoring tool). In some examples, the well tool 114 can include a fluid monitoring tool, a cement monitoring tool, a multi-phase flow monitoring system, a valve, a gauge, a sensor (e.g., a sensor for detecting pressure, strain, temperature, fluid density, fluid viscosity, acoustic vibrations, a chemical, an electric field, a magnetic field, or another parameter), an optical device or system, or any combination of these. The well tool 114 can be positioned in the wellbore 102 via the hybrid electro-optical cable 110. For example, the well tool 114 can be lowered into the wellbore 102 by manipulating a winch 112 or pulley, unreeling the hybrid electro-optical cable 110 from a spool, or both. The hybrid electro-optical cable 110 may be fed through a wellhead exit or feedthrough packers. In some examples, the hybrid electro-optical cable 110 can also be extracted or removed from the wellbore 102 (e.g., to remove the well tool 114 from the wellbore 102).

In some examples, the hybrid electro-optical cable 110 can include a tube, such as a stainless steel tube or a polymer tube, which includes one or more optical fibers. The one or more optical fibers can include an enhanced backscatter fiber and a combination of single-mode fibers and multimode fibers. The tube can be coated in a material with a low hydrogen diffusivity and solubility that acts as a hydrogen-permeation delay barrier. The optical fibers can be used for communicating data between an optical device 118 (e.g., at the well surface 108 or elsewhere in the well system 100) and the well tool 114. For example, the optical device 118 can transmit data encoded in optical signals to another optical device 116 positioned in the well tool 114 via the hybrid electro-optical cable 110. The optical device 116 of the well tool 114 can receive the optical signals and determine the data from the optical signals. As another example, the well tool 114 can transmit data encoded in optical signals to the optical device 118 via the hybrid electro-optical cable 110. The optical device 118 can receive the optical signals and determine the data from the optical signals. In this manner, two-way communication between the optical devices 116 and 118 can be achieved. The hybrid electro-optical cable 110 may be used to communicate distributed acoustic sensing measurements, distributed strain sensing measurements, or distributed temperature sensing measurements between the optical devices 116 and 118.

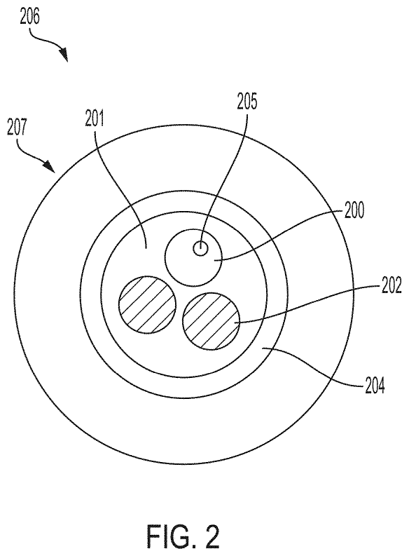

FIG. 2 is a cross-sectional schematic of an example of a hybrid electro-optical cable 206 with insulated conductors and an optical fiber within a tube having a hydrogen-delay barrier according to some aspects of the present disclosure. The hybrid electro-optical cable 206 can be deployed downhole in a wellbore for transmitting data from downhole to an optical device. The hybrid electro-optical cable 206 can include a tube 200 in which one or more optical fibers 205 and one or more insulated conductors 202 are positioned. The tube 200 may be a fiber-in-metal-tube or a polymer tube. The optical fibers 205 can transmit optical signals between one or more optical devices, and the insulated conductors 202 can transmit electricity between surface equipment and a well tool. The optical fibers 205 and insulated conductors 202 may be parallel to each other or twisted helically.

In some examples, the optical fibers 205 may include a Verrillon carbon mid-temp acrylate 50/125 VHM2000 multimode fiber, a Verrillon carbon mid-temp acrylate VHS-100 single mode fiber, a high sensitivity single-mode OFS AcoustiSense fiber, which may increase optical signal-to-noise ratio. At least one of the optical fibers 205 can be an enhanced backscatter fiber that provides above Rayleigh-limited backscattering. The enhanced backscatter fiber can be manufactured to yield 10 to 20 dB optical signal-to-noise ratio (OSNR) gain over native Rayleigh-limited backscatter OSNRs. This may provide improved signal-to-noise ratios in distributed acoustic sensing signals, such as 4D vertical seismic profile imaging. Gains outside of the 10 to 20 dB signal-to-noise ratio range may also be possible. In some examples, the enhanced backscatter fiber can have weak continuous internal reflective optical gratings. In alternative examples, the enhanced backscatter fiber may be formed by discrete periodic internal fiber Bragg gratings at fixed distances along the sensing fiber. Enhanced backscatter may be gauge-length independent of the distributed acoustic sensing measurement in a case of periodic discontinuous internal gratings.

The enhanced backscatter fiber may not be carbon coated, or may be partially carbon coated. A partial carbon coating may be achieved by using a carbon-coated fiber as the base fiber, and damaging or perforating the carbon coating during ultraviolet or laser inscription of the weak gratings or discrete fiber Bragg gratings to photolithographically write or inscribe the reflective grating features deep within the core of the fiber. The enhanced backscatter fiber may additionally be processed prior to installation into the cable for improved hydrogen performance. For example, the enhanced backscatter fiber may be exposed to deuterium (heavy hydrogen with an additional neutron) over a period of time to allow the deuterium to permeate into the fiber to shift attenuation bands towards longer unused optical wavelengths.

In some examples, the insulated conductors 202 can be 18 AWG solid bare copper with black or white fluorinated ethylene propylene insulation. The tube 200 can include a hydrogen scavenging gel 201, which may prevent internal annular hydrogen near the fiber(s) from reaching the surface of the optical fibers 205 by preferentially absorbing and reacting with free hydrogen. The hydrogen scavenging gel 201 may be Sepigel.

In some examples, the hybrid electro-optical cable 206 can include a hydrogen-delay barrier 204 external to the tube 200 and the insulated conductors 202. The hydrogen-delay barrier 204 can be provided to reduce an amount and rate of hydrogen infill flux that can reach and react with the optical fibers 205. The hydrogen-delay barrier 204 may be metallurgical and include fabrication via molten metal bath, an aluminum extrusion, an aluminum tube, a copper tube, a carbon-composite tube or any combination thereof.

The hybrid electro-optical cable 206 can also include an outer tube 207 that can encapsulate the hydrogen-delay barrier 204. The outer tube 207 may be an 825 Alloy Sheath Tube per ASTM B704 and UNS N08825 with a wall thickness of 0.89 mm (0.035″) and an outer diameter of 6.35 mm (0.25″). The outer tube 207 may further be encapsulated by a thermoplastic, such as round Santoprene, for example. The hybrid electro-optical cable 206 may be spliced, such that there is electrical and optical continuity across the splice. The hybrid electro-optical cable 206 may also be in a wireline cable configuration.

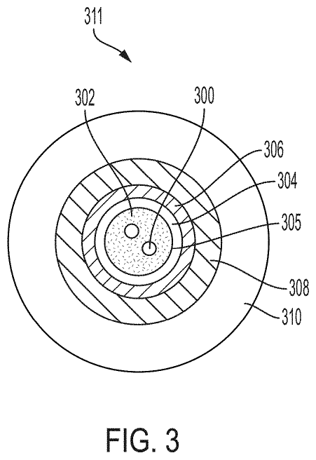

FIG. 3 is a cross-sectional schematic of an example of a hybrid electro-optical cable 311 with a concentric-insulated conductor and tube with a hydrogen-delay barrier according to some aspects of the present disclosure. In some examples, a concentric-insulated conductor may include a conductor layer encapsulated by one or more insulator layers. The conductor layer and insulator layers may be oriented such that the conductor layer and insulator layers are concentric to each other.

In some examples, the hybrid electro-optical cable 311 can include a tube 305 encapsulating one or more optical fibers 300 for communicating optical signals. The optical fibers 300 may include a Verrillon carbon mid-temp acrylate 50/125 VHM2000, a Verrillon carbon mid-temp acrylate VHS-100 single mode fiber, an OFS AcoustiSense fiber, which may be a high sensitivity high OSNR single mode fiber. At least one of the optical fibers 300 can be an enhanced backscatter fiber. The hybrid electro-optical cable 311 can include a hydrogen scavenging gel 302 encapsulated by the tube 305 surrounding the optical fibers 300 which may prevent internal annular hydrogen near the fiber(s) from reaching the surface of the optical fibers 300 by preferentially absorbing and reacting with free hydrogen. The hydrogen scavenging gel 302 may be Sepigel.

In some examples, the hybrid electro-optical cable 311 can include a hydrogen-delay barrier 304 that encapsulates and is concentric with the tube 305. The hydrogen-delay barrier 304 may reduce an amount of hydrogen that reacts with the optical fibers 300. The hydrogen-delay barrier 304 may be metallurgical and include fabrication via molten metal bath, an aluminum extrusion, an aluminum tube, a copper tube, a carbon-composite tube or any combination thereof. The hybrid electro-optical cable may also include a conductor 306 coupled with an insulator 308 to form a concentric-insulated conductor. The conductor 306 may be concentric with the insulator 308. The insulated conductor may be encapsulated by and concentric with an outer tube 310 for protection. In this example, the insulator 308 and conductor 306 may be concentric with the tube 305 containing the one or more optical fibers 300, and the hydrogen-delay barrier 304, and the outer tube 310. The tube 305 can be encapsulated by the concentric-insulated conductor, which can be encapsulated by the outer tube 310.

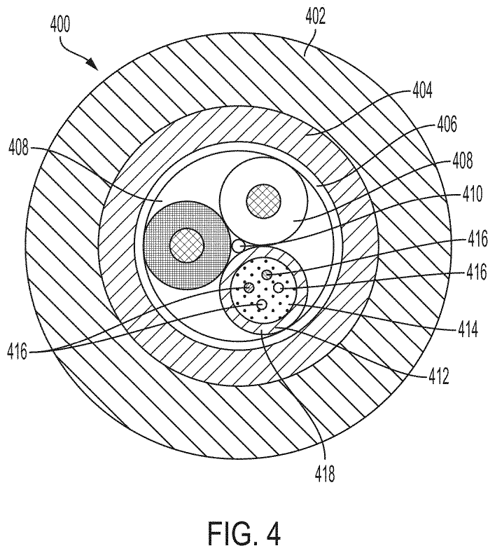

FIG. 4 is a cross-sectional schematic of another example of a hybrid electro-optical cable 400 with insulated conductors and an optical fiber 416 within a tube having a hydrogen-delay barrier according to some aspects of the present disclosure.

In some examples, the hybrid electro-optical cable 400 can include a tube 412 encapsulating one or more optical fibers 416. The tube 412 can further encapsulate a hydrogen scavenging gel 414, which may prevent internal annular hydrogen near the fiber(s) from reaching the surface of the optical fibers 416 by preferentially absorbing and reacting with free hydrogen. The hydrogen scavenging gel 414 may be Sepigel. The optical fibers 416 may include a Verrillon carbon mid-temp acrylate 50/125 VHM2000 multimode fiber, a Verrillon carbon mid-temp acrylate VHS-100 single mode fiber, a high sensitivity single-mode OFS AcoustiSense fiber, which may increase optical signal-to-noise ratio. The optical fibers 416 may not have a full carbon coating. The tube 412 containing the optical fibers 416 and hydrogen scavenging gel 414 can be encapsulated by a hydrogen-delay barrier 418 with a low hydrogen diffusivity to reduce hydrogen darkening.

The hybrid electro-optical cable 400 can also include insulated conductors 408. The insulated conductors 408 can be 18 AWG solid bare copper with fluorinated ethylene propylene insulation. The outer diameter of the tube 412 with the hydrogen-delay barrier 418 can be the same outer diameter as the insulated conductors 408. For example, the outer diameter of the tube 412 with the hydrogen-delay barrier 418 and the insulated conductors 408 can be 1.8 mm (0.070″). The hybrid electro-optical cable 400 may have a central strength member 410. For example, the central strength member 410 can be an epoxy fiberglass rod used to twist the tube 412 and at least one of the insulated conductors 408 together.

In some examples, the insulated conductors 408 and tube 412 can be further encapsulated into a fiber belt 406, such as fluorinated ethylene propylene. The fiber belt 406 can be encapsulated into an outer tube 404. For example, the outer tube 404 can be an 825 Alloy Sheath Tube with a wall thickness of 0.89 mm (0.035″) and an outer diameter of 6.35 mm (0.25″). As another example, the outer tube 404 may be a ¼″ control line made of Iconel A825 or stainless steel. In some examples, the hydrogen-delay barrier 418 may additionally or alternatively be applied between twisted cables of the tube 412 and the outer tube 404. The hybrid electro-optical cable 400 can further include an encapsulation 402 around the outer tube 404 that encapsulates the fiber belt 406. The encapsulation 402 can be a thermoplastic, such as round Santoprene, with an outer diameter of 11.0 mm (0.433″), for example.

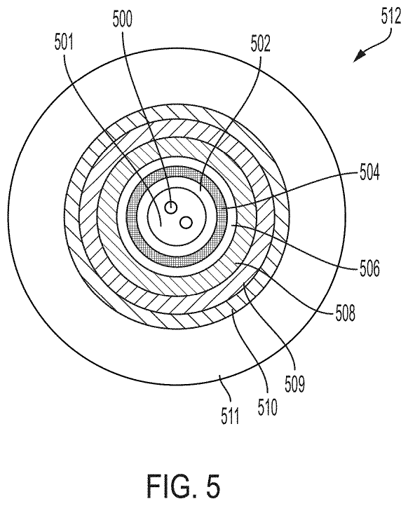

FIG. 5 is a cross-sectional schematic of an example of a hybrid electro-optical cable 512 with multiple concentrically arranged concentric-insulated conductors and a tube with a hydrogen-delay barrier according to some aspects of the present disclosure.

In this example, the hybrid electro-optical cable 512 can include one or more optical fibers 500 for communicating optical signals. The one or more optical fibers 500 may include a Verrillon carbon mid-temp acrylate 50/125 VHM2000 multimode fiber, a Verrillon carbon mid-temp acrylate VHS-100 single mode fiber, a high sensitivity single-mode OFS AcoustiSense fiber, which may have an increased optical signal-to-noise ratio. The hybrid electro-optical cable 512 may be spliced, such that there is electrical and optical continuity across the splice. The hybrid electro-optical cable 512 may also be in a wireline configuration. The hybrid electro-optical cable 512 can include a hydrogen scavenging gel 501, which may prevent hydrogen from reacting with the optical fibers 500 by reacting preferentially with hydrogen.

The one or more optical fibers 500 and the hydrogen scavenging gel 501 may be encapsulated by a tube 502, which may be further encapsulated by a hydrogen-delay barrier 504. The hydrogen-delay barrier 504 may reduce the amount of hydrogen that permeates into the tube 502, thereby reducing the amount of hydrogen that reacts with the optical fibers 500. The hydrogen-delay barrier 504 may be metallurgical and include fabrication via molten metal bath, an aluminum extrusion, an aluminum tube, a copper tube, a carbon-composite tube or any combination thereof. The hybrid electro-optical cable 512 may also include a first conductor layer 506. The first conductor layer 506 may encapsulate the hydrogen-delay barrier 504. The first conductor layer 506 may be a tape made of a metal, such as copper. The first conductor layer 506 may be encapsulated by a first insulation layer 508 to form a concentric-insulated conductor.

In some examples, the first insulation layer 508 may be encapsulated by a second conductor layer 509. The second conductor layer 509 may be insulated on its inner diameter by the first insulation layer 508. The second conductor layer 509 may further insulated on its outer diameter by a second insulation layer 510. The second conductor layer 509 may be a tape made of a metal, such as copper. The second insulation layer 510 may be encapsulated by an outer tube 511 for protection. The outer tube 511 may be a ¼″ control line made of Iconel A825 or stainless steel, which may further by encapsulated by a thermoplastic such as Santoprene.

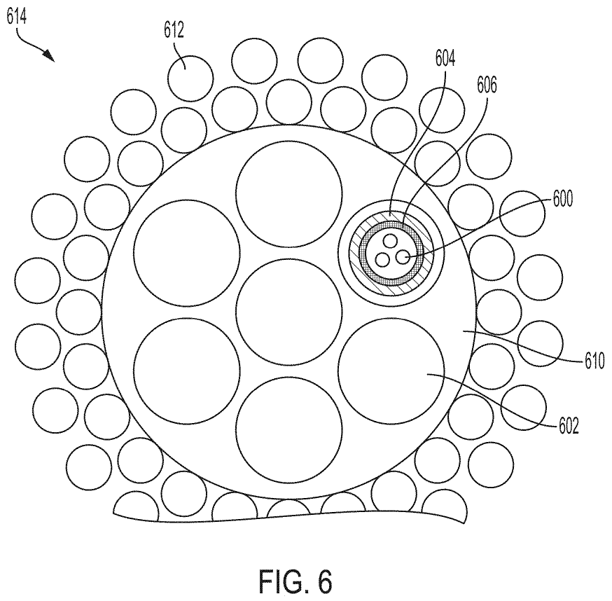

FIG. 6 is a cross-sectional schematic of an example of a wireline-configured hybrid electro-optical cable 614 with a hydrogen-delay barrier for reducing hydrogen darkening according to some aspects of the present disclosure.

The hybrid electro-optical cable 614 can include a tube 604 including one or more optical fibers 600 for communicating optical signals. The tube 604 may be encapsulated by a hydrogen-delay barrier 606 that may reduce an amount of hydrogen that reacts with the optical fibers 600. The hydrogen-delay barrier 606 may be metallurgical and include fabrication via molten metal bath, an aluminum extrusion, an aluminum tube, a copper tube, a carbon-composite tube or any combination thereof. The hybrid electro-optical cable 614 may also include one or more insulated conductors 602, which may be used for conducting electricity between surface equipment and a well tool. The one or more insulated conductors 602 and the tube 604 can be encapsulated into an outer tube 610, which, in a wireline configuration, can be further encapsulated by armor 612. The armor 612 may be made of interlocked steel, interlocked aluminum, or welded aluminum.

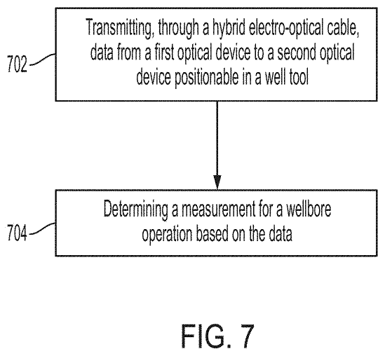

FIG. 7 is a flowchart of a process for using a hybrid electro-optical cable to transmit data during a wellbore operation. The hybrid electro-optical cable may be any of the hybrid electro-optical cables described in FIGS. 2-6.

In block 702, data is transmitted, through a hybrid electro-optical cable, from a first optical device to a second optical device positionable in a well tool. The hybrid electro-optical cable can include a tube including one or more optical fibers for communicating optical signals. The hybrid electro-optical cable can include a hydrogen-delay barrier that may reduce an amount of hydrogen that reacts with the optical fibers. The hydrogen-delay barrier may be metallurgical and include a molten metal bath, an aluminum extrusion, an aluminum tube, a copper tube, or any combination thereof. The hybrid electro-optical cable may also include an insulated conductor capable of conducting electricity. The tube and the one or more insulated conductors can be encapsulated into an outer tube, which can be further encapsulated by a thermoplastic encapsulation. The tube may also include a hydrogen scavenging gel which may prevent internal annular hydrogen near the fiber(s) from reaching the surface of said optical fibers by preferentially absorbing and reacting with free hydrogen. The hydrogen scavenging gel may be Sepigel. The hybrid electro-optical cable may include an enhanced backscatter fiber, which may be capable of above-Rayleigh backscattering. The data may be passed through the hybrid electro-optical cable as one or more optical signals. The data may be encoded in the optical signals via intensity modulation, frequency modulation, or optical phase modulation. The data may be used for distributed acoustic sensing, distributed strain sensing, or distributed temperature sensing.

In block 704, a measurement is determined for a wellbore operation based on the data. The measurement may be used in vertical seismic profiling or reservoir diagnostics. The measurement may be determined with a photodiode or other light-detecting apparatus. The first or second optical device can receive the optical signals from the hybrid electro-optical cable and determine the measurement based on the optical signals. For example, strain measurements, temperature measurements, or other downhole measurements may be determined by the first or second optical device. The measurements may be used to adjust the wellbore operation. For example, drilling or production parameters may be adjusted based on the measurements.

In some aspects, systems and methods for a hybrid electro-optical cable having a hydrogen-delay barrier are provided according to one or more of the following examples:

Example 1 is a system comprising a tube comprising one or more optical fibers, a hydrogen-delay barrier encapsulating the tube, an insulated conductor, and an outer tube encapsulating the hydrogen-delay barrier and the insulated conductor.

Example 2 is the system of example 1, wherein the hydrogen-delay barrier is positionable between the tube and the outer tube, and the system further comprises a thermoplastic encapsulation encapsulating the outer tube.

Example 3 is the system of example 1, further comprising: a hydrogen scavenging gel within the tube and encapsulating the one or more optical fibers for reducing a hydrogen-darkening effect.

Example 4 is the system of example 1, wherein the insulated conductor is positionable external to the tube and is configured to have a same outer diameter as the tube with the hydrogen-delay barrier.

Example 5 is the system of example 1, wherein the tube is configured to be twisted with the insulated conductor within the outer tube.

Example 6 is the system of example 1, wherein at least one of the one or more optical fibers is an enhanced backscatter fiber for providing above-Rayleigh backscattering.

Example 7 is the system of example 1, wherein the insulated conductor is a concentric-insulated conductor comprising a conductor layer and one or more insulator layers, and the insulated conductor is configured to encapsulate and be concentric with the tube.

Example 8 is the system of example 1, wherein the hydrogen-delay barrier comprises a molten metal bath, an aluminum extrusion, an aluminum tube, or a copper tube.

Example 9 is a method comprising: transmitting, through a hybrid electro-optical cable, data from a first optical device to a second optical device positionable in a well tool, the hybrid electro-optical cable comprising: a tube comprising one or more optical fibers, a hydrogen-delay barrier encapsulating the tube, an insulated conductor, and an outer tube encapsulating the hydrogen-delay barrier and the insulated conductor, and determining a measurement for a wellbore operation based on the data.

Example 10 is the method of example 9, wherein the hydrogen-delay barrier is positionable between the tube and the outer tube, the hybrid electro-optical cable further comprising a thermoplastic encapsulation that encapsulates the outer tube.

Example 11 is the method of example 9, wherein a hydrogen scavenging gel within the tube encapsulates the one or more optical fibers for reducing a hydrogen-darkening effect.

Example 12 is the method of example 9, wherein the hydrogen-delay barrier comprises a molten metal bath, an aluminum extrusion, an aluminum tube, or a copper tube.

Example 13 is the method of example 9, wherein at least one of the one or more optical fibers is an enhanced backscatter fiber for providing above-Rayleigh backscattering.

Example 14 is the method of example 9, wherein the insulated conductor is a concentric-insulated conductor comprising a conductor layer and one or more insulator layers, the insulated conductor being configured to encapsulate and be concentric with the tube.

Example 15 is the method of example 9, wherein the insulated conductor is positionable external to the tube and is configured to have a same outer diameter of the tube with the hydrogen-delay.

Example 16 is a system comprising: a tool for performing a wellbore operation, and a cable communicatively coupled to the tool for providing communication for the tool, wherein the cable includes a hydrogen-delay barrier encapsulating a tube that includes one or more optical fibers.

Example 17 is the system of example 16, wherein the cable further includes: an outer tube configured to encapsulate the hydrogen-delay barrier, an insulated conductor positionable between the tube and the outer tube, and a thermoplastic encapsulation configured to encapsulate the outer tube.

Example 18 is the system of example 16, further comprising: a hydrogen scavenging gel within the tube encapsulating the one or more optical fibers for reducing a hydrogen darkening effect.

Example 19 is the system of example 17, wherein the tube is configured to be twisted with the insulated conductor within the outer tube.

Example 20 is the system of example 16, wherein at least one of the one or more optical fibers is an enhanced backscatter fiber for providing above-Rayleigh backscattering.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a tube comprising one or more optical fibers;
a hydrogen-delay barrier encapsulating the tube;
an insulated conductor; and
an outer tube encapsulating the hydrogen-delay barrier and the insulated conductor.

2. The system of claim 1, wherein the hydrogen-delay barrier is positionable between the tube and the outer tube, the system further comprising:
a thermoplastic encapsulation encapsulating the outer tube.

3. The system of claim 1, further comprising:
a hydrogen scavenging gel within the tube and encapsulating the one or more optical fibers for reducing a hydrogen-darkening effect.

4. The system of claim 1, wherein the insulated conductor is positionable external to the tube and is configured to have a same outer diameter as the tube with the hydrogen-delay barrier.

5. The system of claim 1, wherein the tube is configured to be twisted with the insulated conductor within the outer tube.

6. The system of claim 1, wherein at least one of the one or more optical fibers is an enhanced backscatter fiber for providing above-Rayleigh backscattering.

7. The system of claim 1, wherein the insulated conductor is a concentric-insulated conductor comprising a conductor layer and one or more insulator layers, and the insulated conductor is configured to encapsulate and be concentric with the tube.

8. The system of claim 1, wherein the hydrogen-delay barrier comprises a molten metal bath, an aluminum extrusion, an aluminum tube, or a copper tube.

9. A method comprising:
transmitting, through a hybrid electro-optical cable, data from a first optical device to a second optical device positionable in a well tool, the hybrid electro-optical cable comprising:
a tube comprising one or more optical fibers;
a hydrogen-delay barrier encapsulating the tube;
an insulated conductor; and
an outer tube encapsulating the hydrogen-delay barrier and the insulated conductor; and
determining a measurement for a wellbore operation based on the data.

10. The method of claim 9, wherein the hydrogen-delay barrier is positionable between the tube and the outer tube, the hybrid electro-optical cable further comprising a thermoplastic encapsulation that encapsulates the outer tube.

11. The method of claim 9, wherein a hydrogen scavenging gel within the tube encapsulates the one or more optical fibers for reducing a hydrogen-darkening effect.

12. The method of claim 9, wherein the hydrogen-delay barrier comprises a molten metal bath, an aluminum extrusion, an aluminum tube, or a copper tube.

13. The method of claim 9, wherein at least one of the one or more optical fibers is an enhanced backscatter fiber for providing above-Rayleigh backscattering.

14. The method of claim 9, wherein the insulated conductor is a concentric-insulated conductor comprising a conductor layer and one or more insulator layers, the insulated conductor being configured to encapsulate and be concentric with the tube.

15. The method of claim 9, wherein the insulated conductor is positionable external to the tube and is configured to have a same outer diameter of the tube with the hydrogen-delay.

16. A system comprising:
a tool for performing a wellbore operation; and
a cable communicatively coupled to the tool for providing communication for the tool, wherein the cable includes a hydrogen-delay barrier encapsulating a tube that includes one or more optical fibers.

17. The system of claim 16, wherein the cable further includes:
an outer tube configured to encapsulate the hydrogen-delay barrier;
an insulated conductor positionable between the tube and the outer tube; and
a thermoplastic encapsulation configured to encapsulate the outer tube.

18. The system of claim 16, further comprising:
a hydrogen scavenging gel within the tube encapsulating the one or more optical fibers for reducing a hydrogen darkening effect.

19. The system of claim 17, wherein the tube is configured to be twisted with the insulated conductor within the outer tube.

20. The system of claim 16, wherein at least one of the one or more optical fibers is an enhanced backscatter fiber for providing above-Rayleigh backscattering.
